(19) United States
(12) Patent Application Publication
(10) Pub. No.: US 2017/0286537 A1
(43) Pub. Date: Oct. 5, 2017

(54) CONTENT BROWSING ON A VEHICULAR DISPLAY

(71) Applicant: Google Inc., Mountain View, CA (US)

(72) Inventors: Evan Malahy, Sunnyvale, CA (US); Donald Geoffrey Schuller, San Jose, CA (US); German W. Bauer, San Jose, CA (US); Gregory Mason Neiswander, Sunnyvale, CA (US); Andrew Scott Brenner, Sunnyvale, CA (US)

(21) Appl. No.: 15/088,778

(22) Filed: Apr. 1, 2016

(51) Int. Cl. G06F 17/30; H04L 29/08

(52) U.S. Cl. CPC G06F 17/30761; H04L 67/12; G06F 17/30554

(57) ABSTRACT

In some implementations, user input specifying a character to be included in a search query is received and a determination is made (i) that all identified search results responsive to the search query can be simultaneously provided on a display, (ii) that adding one or more additional characters to the search query up to a maximum number of characters will not reduce the number of search results responsive to the search query to a number greater than zero, or (iii) that the search query includes the maximum number of characters. Search results are provided on the display in response to the determination.

### FIELD

This specification describes technologies related to a vehicular graphical user interface.

### BACKGROUND

Content browsers may be used to find content on computing devices. For example, a computer may store one thousand songs and display an interface of a content browser for a user to browse through the songs and select a song to play.

### SUMMARY

Reducing the number of interactions needed for a user to complete a task may be very important in a content browsing system for a vehicle. Interactions may include taps on a touch screen, depresses of button, or other forms of interacting with an interface. For example, if a user wishes to select a song while driving, the more taps on a touchscreen needed by a user to select the song, the longer the user is likely to be distracted from driving. Accordingly, a content browsing system for a vehicle, also referred to hereinafter as a vehicular content browsing system, may provide a user experience that attempts to reduce the number of interactions needed by a user to complete a task.

In the case where the task is selecting a content item from a set of content items, the vehicular content browsing system may attempt to reduce the number of interactions needed by a user to select the content item by providing a search query input interface for a user to enter a search query for finding the content item, and automatically closing the search query input interface when the search query satisfies criteria for providing search results for display. By automatically closing the search query input interface when the search query satisfies criteria for providing search results for display, the vehicular content browsing system may avoid interactions where the user explicitly closes the search query input interface and may potentially avoid providing so many search results that a user needs to interact to browse or scroll through the search results to select a content item.

Accordingly, the user may learn to trust that the vehicular content browsing system will close a search query input interface and automatically display search results at the earliest time that results in an appropriate reduction in interactions. As a result, the vehicular content browsing system may reduce the number of interactions that users need to perform tasks, which may reduce the amount of time needed to perform tasks, which may reduce the amount of time that users are distracted while driving.

In a general aspect, a method for content browsing includes receiving user input specifying a character to be included in a search query and determining (i) that all identified search results responsive to the search query can be simultaneously provided on a display, (ii) that adding one or more additional characters to the search query up to a maximum number of characters will not reduce the number of search results responsive to the search query to a number greater than zero, or (iii) that the search query includes the maximum number of characters, and providing the search results on the display in response to determining (i) that all identified search results responsive to the search query can be simultaneously provided on the display, (ii) that adding one or more additional characters to the search query up to the maximum number of characters will not reduce the number of search results responsive to the search query to a number greater than zero, or (iii) that the search query includes the maximum number of characters.

Other implementations of this and other aspects include corresponding systems, apparatus, and computer programs, configured to perform the actions of the methods, encoded on computer storage devices. A system of one or more computers can be so configured by virtue of software, firmware, hardware, or a combination of them installed on the system that in operation cause the system to perform the actions. One or more computer programs can be so configured by virtue of having instructions that, when executed by data processing apparatus, cause the apparatus to perform the actions.

Implementations may include one or more of the following features. For instance, the display is mounted to, or integrated into, a dashboard of a vehicle. In some aspects, providing the search results on the display in response to determining (i) that all identified search results responsive to the search query can be simultaneously provided on the display, (ii) that adding one or more additional characters to the search query up to the maximum number of characters will not reduce the number of search results responsive to the search query to a number greater than zero, or (iii) that the search query includes the maximum number of characters includes providing the search results on the display in response to determining that all identified search results responsive to the search query can be simultaneously provided on the display.

In certain aspects, determining that all identified search results responsive to the search query can be simultaneously provided on a display includes determining a number of search results that can be simultaneously provided on the display, determining the number of search results responsive to the search query, and determining that the number of search results responsive to the search query is equal to or less than the number of search results that can be simultaneously provided on the display. In some implementations, providing the search results on the display in response to determining (i) that all identified search results responsive to the search query can be simultaneously provided on the display, (ii) that adding one or more additional characters to the search query up to the maximum number of characters will not reduce the number of search results responsive to the search query to a number greater than zero, or (iii) that the search query includes the maximum number of characters includes providing the search results on the display in response to determining that adding one or more additional characters to the search query up to the maximum number of characters will not reduce the number of search results responsive to the search query to a number greater than zero.

In some aspects, determining that adding one or more additional characters to the search query up to the maximum number of characters will not reduce the number of search results responsive to the search query to a number greater than zero includes determining that adding any character to the search query when the search query includes less than the maximum number of characters either results in no search results being responsive to the search query or a same set of results being responsive to the search query.

In certain aspects, providing the search results on the display in response to determining (i) that all identified search results responsive to the search query can be simultaneously provided on a display, (ii) that adding one or more additional characters to the search query up to the maximum number of characters will not reduce the number of search results responsive to the search query to a number greater than zero, or (iii) that the search query includes the maximum number of characters includes providing the search results on the display in response to determining that the search query includes the maximum number of characters. In some implementations, determining that the search query includes the maximum number of characters includes determining the maximum number of characters that can be included in search queries and determining that the number of characters in the search query equals the maximum number of characters that can be included in search queries.

In some aspects, the characters comprise alphanumeric characters. In certain aspects, a search result is responsive to a search query when any word in a title of the search result begins with the characters in the search query. In some implementations, receiving user input specifying a character to be included in a search query includes appending the character to the search query. In some aspects, the display is used in a vehicle or transportation device.

The details of one or more embodiments of the subject matter described in this specification are set forth in the accompanying drawings and the description below. Other potential features, aspects, and advantages of the subject matter will become apparent from the description, the drawings, and the claims.

### BRIEF DESCRIPTION OF THE DRAWINGS

FIG. 1 is a block diagram that illustrates example graphical user interfaces provided by a vehicular content browsing system.

FIG. 2 is a block diagram of a vehicular content browsing system.

FIG. 3 is a flow diagram that illustrates an example of a process for vehicular content browsing.

FIG. 4 is a diagram of examples of computing devices.

Like reference numbers and designations in the various drawings indicate like elements.

### DETAILED DESCRIPTION

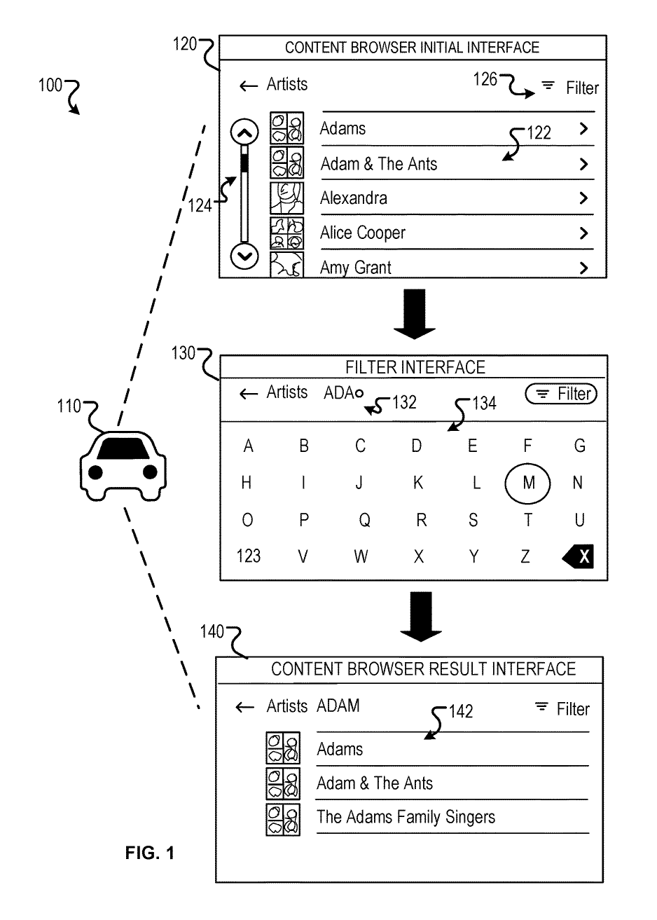

FIG. 1 is a block diagram that illustrates example graphical user interfaces provided by a vehicular content browsing system 100. The vehicular content browsing system 100 may be included in a vehicle 110 and the graphical user interfaces may include a content browser initial interface 120, a filter interface 130, and a content browser result interface 140. The graphical user interfaces may be provided on a display mounted to, or integrated into, a dashboard of the vehicle 110. The vehicle 110 may include a car, a truck, an airplane, a boat, or another machine that can transport a person.

The vehicular content browsing system 100 may have access to multiple content items, e.g., songs, videos, documents, contact records, or other items. When a user wishes to select a content item, e.g., to play a song, to watch a video, to view a document, or to perform some other action, the user may trigger the opening of the content browser initial interface 120. For example, the user may click on a button labeled “Select an artist” to select a content item, e.g., an artist. The content browser initial interface 120 may include a content item display area 122 for displaying multiple content items, a scroll bar 124 for scrolling through the multiple content items, and a filter control 126 for displaying the filter interface 130 for providing a search query to filter the displayed content items.

The content item display area 122 may be able to display a few content items at a time. For example, the content item display area 122 may have room to only simultaneously display five content items, three content items, or some other number of content items out of hundreds of content items. The scroll bar 124 may enable the user to scroll through the content items so that the user may select a content item that is not currently displayed. In other implementations other controls besides a scroll bar 124 may be used. For example, the content browser initial interface 120 may include controls for “Previous page” or “Next page” to display a previous page of results or a next page of results. Accordingly, a user may make multiple interactions to find and select a content item. The filter control 126 may be an interface element that causes the vehicular content browsing system 100 to display the filter interface 130. For example, the filter control 126 may be a button labeled “Filter” that can be selected by a user to replace the content browser initial interface 120 with the filter interface 130.

The filter interface 130 may include a search query field 132 that enables a user to enter a search query. A search query may also be considered a filter query or narrowing query. Using a search query may enable a user to potentially select a content item with fewer interactions than using the scroll bar 124 to scroll through a list of content items. For example, a user may use a search query of “ZE” to filter artists to just “Zedd” and click a search result of “Zedd” instead of scrolling through a long list of all artists available.

The search query field 132 may initially be empty and may be filled sequentially character by character based on user input. For example, after a user selects the characters “A,” “D,” and “A,” the search query field 132 may include the search query “ADA.” The filter interface 130 may include a character input control 134 that may be a control through which a user may input characters to include in the search query field 132. For example, the character input control 134 may be a virtual keyboard displayed in the interface, a freeform area that enables a user to draw a character that is recognized by the vehicular content browsing system 100, or some other type of control that allows input of characters. Characters may include one or more of letters, numerical digits, alphanumeric characters, symbols, or punctuation marks.

The vehicular content browsing system 100 may continuously determine whether the current search query in the search query field 132 satisfies criteria for providing search results for display. The criteria may be intended to reduce the number of interactions made by a user to select a content item. For example, criteria may include one or more of (i) determining that all the search results responsive to the current search query may be simultaneously shown on a single screen, (ii) determining that a maximum number of characters are included in the current search query, or (iii) determining that adding one or more additional characters to the search query up to the maximum number of characters will not reduce the number of search results without eliminating all search results.

Once the vehicular content browsing system 100 determines that the criteria for providing search results for display is satisfied, the vehicular content browsing system 100 may stop providing the filter interface 130 and instead provide the content browser result interface 140. Accordingly, the vehicular content browsing system 100 may avoid having a user perform a specific interaction just to close the filter interface 130. For example, where the content browser result interface 140 may only be able to simultaneously display four search results and five artists are responsive to the search query “ADA,” once a character “M” is added to the search query, without further user input, the vehicular content browsing system 100 may determine that there are three artists that are responsive to the query “ADAM” and three artists can be simultaneously displayed, and in response, provide the content browser result interface 140.

The user may know that the vehicular content browsing system 100 will automatically show the content browser result interface 140 at an appropriate time. As a result, the user may be reassured that adding one or more additional characters to the search query will limit the search results, and the user may avoid prematurely providing an explicit request for search results using a search query that does not include a character that would have significantly reduced the number of search results.

The content browser result interface 140 may include a search results area 142 that shows the search results to the search query. For example, the search results area 142 for a search query “ADAM” may show the search results “Adam,” “Adam & The Ants,” and “The Adams Family Singers.” As discussed above, the content browser result interface 140 may only be able to simultaneously show a certain number of search results, e.g., three, five, four, or some other number.

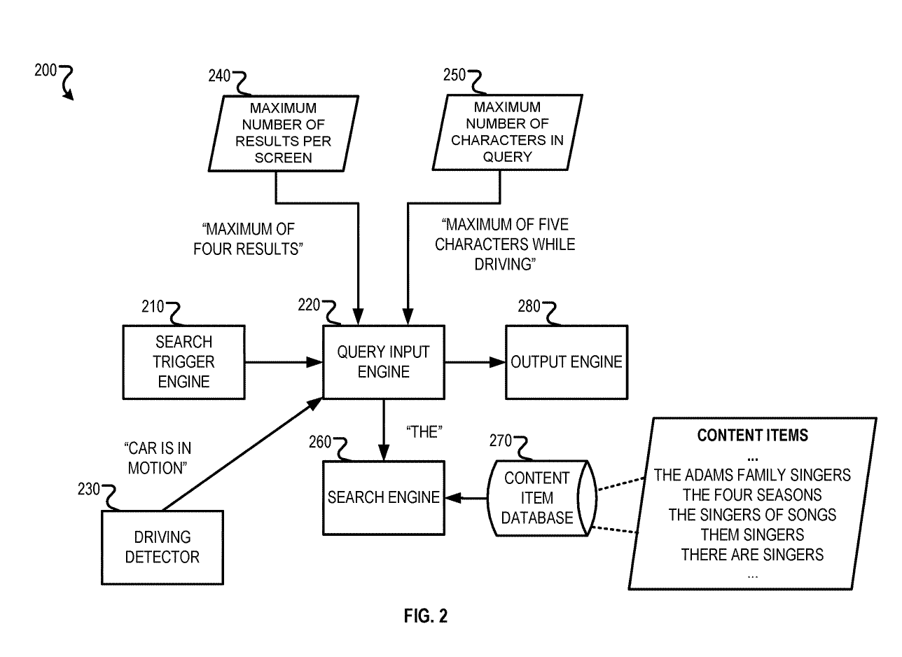

FIG. 2 is a block diagram of a vehicular content browsing system 200. In some implementations, the vehicular content browsing system 200 may perform the functions described in FIG. 1 in relation to the vehicular content browsing system 100. The system 200 may include a search trigger engine 210, a query input engine 220, a driving detector 230, a maximum number of results per screen data source 240, a maximum number of characters in query data source 250, a search engine 260, a content item database 270, and an output engine 280.

The search trigger engine 210 may be an engine that determines when to provide a search query input interface. For example, the search trigger engine 210 may determine when to provide the filter interface 130 on a display of the vehicle 110. The search trigger engine 210 may determine when to provide the search query input interface based on determining that a user has provided input that is associated with providing a search query. For example, the search trigger engine 210 may detect that a user has clicked on a “Filter” button shown in the content browser initial interface 120. When the search trigger engine 210 determines to provide a search query input interface, the search trigger engine 210 may provide an indication to the query input engine 220 to provide the search query input interface.

The driving detector 230 may determine whether a vehicle that includes the vehicular content browsing system 200 is being driven and provide an indication to the query input engine 220. For example, the driving detector 230 may determine that a vehicle is travelling at more than five miles per hour and in response, provide an indication to the query input engine 220 that the vehicle is being driven. In another example, the driving detector 230 may determine that the vehicle is travelling at eight miles per hour but the vehicle's wheels are not rotating, e.g., vehicle is on a ferry boat, and in response, provide an indication to the query input engine 220 that the vehicle is not being driven.

The maximum number of results per screen data source 240 may provide the query input engine 220 an indication of the number of search results that can be simultaneously shown in a results screen. For example, the data source 240 may provide the query input engine 220 an indication that a maximum of four results can be shown. In some implementations, the data source 240 may determine the maximum number based on one or more of user preferences of selected screen resolution, selected number of search results to show on a screen, or other preferences and manufacturer settings, e.g., screen size, font size, or other settings. In another implementations, the source 240 may store a constant pre-determined maximum and just provide the maximum to the query input engine 220.

The maximum number of characters in a query data source 250 may provide the query input engine 220 an indication of the maximum number of characters that can be included in a search query. For example, the data source 250 may specify that while the vehicle is being driven the search query can include a maximum of two, five, four, six or some other number of characters and while the vehicle is not being driven the search query can include a maximum of ten, nine, unlimited, or some other number of characters.

The search engine 260 may be an engine that identifies content items in a content item database 270 that are responsive to a search query. For example, the search engine 260 may receive a search query of “THE” from the query input engine 220, determine that the artists “The Adams Family Singers,” “The Four Seasons,” “The Singers Of Songs,” “Them Singers,” and “There Are Singers” are responsive to the search query and provide information describing the search results to the query input engine 220. In some implementations, the search engine 260 may determine that a content item is responsive to a search query based on determining that the content item includes a word in the content item's title that beings with the search query. In other implementations, the search engine 260 may determine that a content item is responsive to a search based on other factors, e.g., the search query appears anywhere in a title of the content item.

The query input engine 220 may handle search query input and determine when to provide search results. For example, the query input engine 220 may handle receiving a search query of “THE” and then user input adding an additional character of “M” making the search query “THEM,” and in response, determine to provide search results of “THEM SINGERS” without further user input. The query input engine 220 may determine to provide search results in response to one or more of (i) determining that a number of search results responsive to the current search query may be simultaneously shown on a single screen, (ii) determining that a maximum number of characters are included in the current search query, or (iii) determining that adding one or more additional characters to the search query up to the maximum number of characters will not reduce the number of search results without eliminating all search results.

The query input engine 220 may determine that a number of search results responsive to the current search query may be simultaneously shown on a single screen based on the maximum number of results per screen, received from the maximum number of results per screen data source 240, and the number of search results, received from the search engine 260. The number of search results responsive to the current search query may be all the identified search results responsive to the search query. In some implementations, the query input engine 220 may determine a number of search results that can be simultaneously provided on the display, determine the number of search results responsive to the search query, and determine that the number of search results responsive to the search query is equal to or less than the number of search results that can be simultaneously provided on the display.

For example, the query input engine 220 may receive an indication from the maximum number of results per screen data source 240 that the maximum number of results per screen is four results, receive an indication from the search engine 260 that one search result is responsive to a search query “THEM,” and determine that one search result is less than the maximum of four results per screen so all the search results responsive to the current search query may be simultaneously shown on a single screen. In another example, the query input engine 220 may receive an indication from the maximum number of results per screen data source 240 that the maximum number of results per screen is four results, receive an indication from the search engine 260 that five search results are responsive to a search query “THE,” and determine that five search results is greater than the maximum of four results per screen so all the search results responsive to the current search query may not be simultaneously shown on a single screen.

The query input engine 220 may determine that a maximum number of characters are included in the current search query based on determining whether the vehicle is being driven and the maximum number of characters in the search query. For example, the query input engine 220 may receive an indication from the driving detector 230 that the vehicle is being driven, and in response, determine a maximum number of characters in the search query is five and that a current number of characters in the search query is five so that a maximum number of characters are included in the current search query.

In another example, the query input engine 220 may receive an indication from the driving detector 230 that the vehicle is not being driven, and in response, determine a maximum number of characters in the search query is ten and that a current number of characters in the search query is five so determine that a maximum number of characters are not included in the current search query.

The query input engine 220 may determine that adding one or more additional characters to the search query up to the maximum number of characters will not reduce the number of search results without eliminating all search results based on determining whether the vehicle is being driven, the maximum number of characters in the search query, and the number of search results for search queries with additional characters up to the maximum number of characters. For example, the query input engine 220 may determine that a vehicle is in motion so the maximum number of characters in the search query is four, for the current search query “SIN” adding any character up to the maximum of four characters either results in zero search results or the same number of search results, and in response, determine that adding one or more additional characters to the search query up to the maximum number of characters will not reduce the number of search results without eliminating all search results.

In another example, the query input engine 220 may determine that a vehicle is in motion so the maximum number of characters in the search query is four, for the current search query “SI” adding the character “N” reduces the number of search results from ten to five, and in response, determine that adding one or more additional characters to the search query up to the maximum number of characters will reduce the number of search results without eliminating all search results

In response to determining to provide search results, the query input interface may close the filter interface and provide the search results for the output engine 280 to display. For example, the output engine 280 may provide the content browser result interface 140 including the search results on the display of the vehicle.

Different configurations of the system 200 may be used where functionality of the search trigger engine 210, the query input engine 220, the driving detector 230, the maximum number of results per screen data source 240, the maximum number of characters in query data source 250, the search engine 260, the content item database 270, and the output engine 280 may be combined, further separated, distributed, or interchanged. The system 200 may be implemented in a single device or distributed across multiple devices.

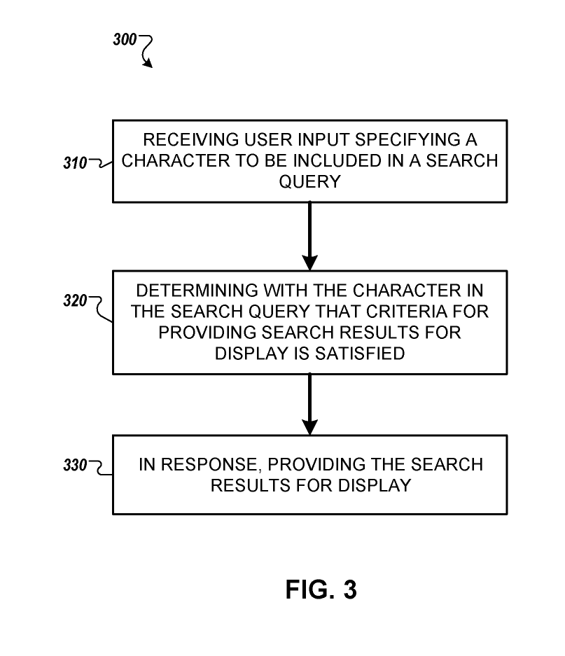

FIG. 3 is a flow diagram that illustrates an example of a process 300 for vehicular content browsing. The operations of the process 300 may be performed by one or more computing systems, such as the system 200 of FIG. 2.

User input specifying a character to be included in a search query is received (310). For example, the query input engine 220 may receive a selection of the letter “C” to add to a search query “BA.”

A determination may be made that with the character in the search query, criteria for providing search results for display is satisfied (320). For example, the query input engine 220 may determine that the search query “BAC” has two search results which can both be simultaneously shown on a screen of a vehicle. In another example, the query input engine 220 may determine that the search query “BACK” includes a maximum of four characters. In yet another example, the query input engine 220 may determine that adding on or more characters to the search query “AZ” up to four total characters either results in zero search results or no reduction in the number of search results.

In response to the determination that with the character in the search query, criteria for providing search results for display is satisfied, the search results may be displayed (330). For example, when the query input engine 220 determines that the search query “BAC” has two search results which can both be simultaneously shown on a screen of a vehicle, the query input engine 220 may instruct the output engine 280 to provide a content browser result interface including both search results.

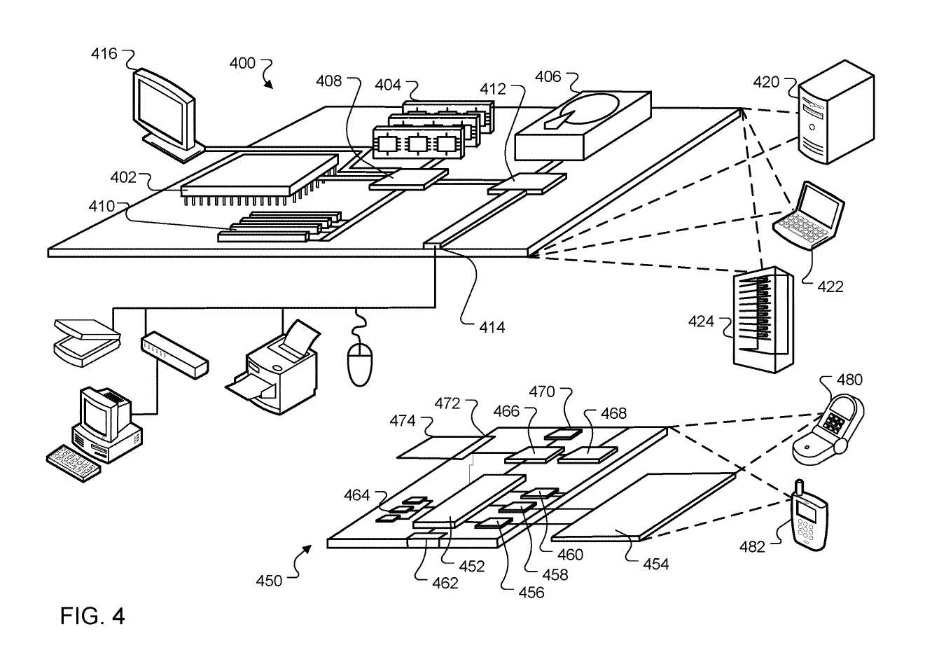

FIG. 4 shows an example of a computing device 400 and a mobile computing device 450 that can be used to implement the techniques described here. The computing device 400 is intended to represent various forms of digital computers, such as laptops, desktops, workstations, personal digital assistants, servers, blade servers, mainframes, and other appropriate computers. The mobile computing device 450 is intended to represent various forms of mobile devices, such as personal digital assistants, cellular telephones, smart-phones, and other similar computing devices. The components shown here, their connections and relationships, and their functions, are meant to be examples only, and are not meant to be limiting.

The computing device 400 includes a processor 402, a memory 404, a storage device 406, a high-speed interface 408 connecting to the memory 404 and multiple high-speed expansion ports 410, and a low-speed interface 412 connecting to a low-speed expansion port 414 and the storage device 406. Each of the processor 402, the memory 404, the storage device 406, the high-speed interface 408, the high-speed expansion ports 410, and the low-speed interface 412, are interconnected using various busses, and may be mounted on a common motherboard or in other manners as appropriate. The processor 402 can process instructions for execution within the computing device 400, including instructions stored in the memory 404 or on the storage device 406 to display graphical information for a graphical user interface (GUI) on an external input/output device, such as a display 416 coupled to the high-speed interface 408. In other implementations, multiple processors and/or multiple buses may be used, as appropriate, along with multiple memories and types of memory. Also, multiple computing devices may be connected, with each device providing portions of the necessary operations (e.g., as a server bank, a group of blade servers, or a multi-processor system).

The memory 404 stores information within the computing device 400. In some implementations, the memory 404 is a volatile memory unit or units. In some implementations, the memory 404 is a non-volatile memory unit or units. The memory 404 may also be another form of computer-readable medium, such as a magnetic or optical disk.

The storage device 406 is capable of providing mass storage for the computing device 400. In some implementations, the storage device 406 may be or contain a computer-readable medium, such as a floppy disk device, a hard disk device, an optical disk device, or a tape device, a flash memory or other similar solid state memory device, or an array of devices, including devices in a storage area network or other configurations. Instructions can be stored in an information carrier. The instructions, when executed by one or more processing devices (for example, processor 402), perform one or more methods, such as those described above. The instructions can also be stored by one or more storage devices such as computer- or machine-readable mediums (for example, the memory 404, the storage device 406, or memory on the processor 402).

The high-speed interface 408 manages bandwidth-intensive operations for the computing device 400, while the low-speed interface 412 manages lower bandwidth-intensive operations. Such allocation of functions is an example only. In some implementations, the high-speed interface 408 is coupled to the memory 404, the display 416 (e.g., through a graphics processor or accelerator), and to the high-speed expansion ports 410, which may accept various expansion cards (not shown). In the implementation, the low-speed interface 412 is coupled to the storage device 406 and the low-speed expansion port 414. The low-speed expansion port 414, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 400 may be implemented in a number of different forms, as shown in the figure. For example, it may be implemented as a standard server 420, or multiple times in a group of such servers. In addition, it may be implemented in a personal computer such as a laptop computer 422. It may also be implemented as part of a rack server system 424. Alternatively, components from the computing device 400 may be combined with other components in a mobile device (not shown), such as a mobile computing device 450. Each of such devices may contain one or more of the computing device 400 and the mobile computing device 450, and an entire system may be made up of multiple computing devices communicating with each other.

The mobile computing device 450 includes a processor 452, a memory 464, an input/output device such as a display 454, a communication interface 466, and a transceiver 468, among other components. The mobile computing device 450 may also be provided with a storage device, such as a micro-drive or other device, to provide additional storage. Each of the processor 452, the memory 464, the display 454, the communication interface 466, and the transceiver 468, are interconnected using various buses, and several of the components may be mounted on a common motherboard or in other manners as appropriate.

The processor 452 can execute instructions within the mobile computing device 450, including instructions stored in the memory 464. The processor 452 may be implemented as a chipset of chips that include separate and multiple analog and digital processors. The processor 452 may provide, for example, for coordination of the other components of the mobile computing device 450, such as control of user interfaces, applications run by the mobile computing device 450, and wireless communication by the mobile computing device 450.

The processor 452 may communicate with a user through a control interface 458 and a display interface 456 coupled to the display 454. The display 454 may be, for example, a TFT (Thin-Film-Transistor Liquid Crystal Display) display or an OLED (Organic Light Emitting Diode) display, or other appropriate display technology. The display interface 456 may comprise appropriate circuitry for driving the display 454 to present graphical and other information to a user. The control interface 458 may receive commands from a user and convert them for submission to the processor 452. In addition, an external interface 462 may provide communication with the processor 452, so as to enable near area communication of the mobile computing device 450 with other devices. The external interface 462 may provide, for example, for wired communication in some implementations, or for wireless communication in other implementations, and multiple interfaces may also be used.

The memory 464 stores information within the mobile computing device 450. The memory 464 can be implemented as one or more of a computer-readable medium or media, a volatile memory unit or units, or a non-volatile memory unit or units. An expansion memory 474 may also be provided and connected to the mobile computing device 450 through an expansion interface 472, which may include, for example, a SIMM (Single In Line Memory Module) card interface. The expansion memory 474 may provide extra storage space for the mobile computing device 450, or may also store applications or other information for the mobile computing device 450. Specifically, the expansion memory 474 may include instructions to carry out or supplement the processes described above, and may include secure information also. Thus, for example, the expansion memory 474 may be provided as a security module for the mobile computing device 450, and may be programmed with instructions that permit secure use of the mobile computing device 450. In addition, secure applications may be provided via the SIMM cards, along with additional information, such as placing identifying information on the SIMM card in a non-hackable manner.

The memory may include, for example, flash memory and/or NVRAM memory (non-volatile random access memory), as discussed below. In some implementations, instructions are stored in an information carrier that the instructions, when executed by one or more processing devices (for example, processor 452), perform one or more methods, such as those described above. The instructions can also be stored by one or more storage devices, such as one or more computer- or machine-readable mediums (for example, the memory 464, the expansion memory 474, or memory on the processor 452). In some implementations, the instructions can be received in a propagated signal, for example, over the transceiver 468 or the external interface 462.

The mobile computing device 450 may communicate wirelessly through the communication interface 466, which may include digital signal processing circuitry where necessary. The communication interface 466 may provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), among others. Such communication may occur, for example, through the transceiver 468 using a radio-frequency. In addition, short-range communication may occur, such as using a Bluetooth, WiFi, or other such transceiver (not shown). In addition, a GPS (Global Positioning System) receiver module 470 may provide additional navigation- and location-related wireless data to the mobile computing device 450, which may be used as appropriate by applications running on the mobile computing device 450.

The mobile computing device 450 may also communicate audibly using an audio codec 460, which may receive spoken information from a user and convert it to usable digital information. The audio codec 460 may likewise generate audible sound for a user, such as through a speaker, e.g., in a handset of the mobile computing device 450. Such sound may include sound from voice telephone calls, may include recorded sound (e.g., voice messages, music files, etc.) and may also include sound generated by applications operating on the mobile computing device 450.

The mobile computing device 450 may be implemented in a number of different forms, as shown in the figure. For example, it may be implemented as a cellular telephone 480. It may also be implemented as part of a smart-phone 482, personal digital assistant, or other similar mobile device.

What is claimed is:

1. A method performed by data processing apparatus, the method comprising:
receiving user input specifying a character to be included in a search query;
determining (i) that all identified search results responsive to the search query can be simultaneously provided on a display, (ii) that adding one or more additional characters to the search query up to a maximum number of characters will not reduce the number of search results responsive to the search query to a number greater than zero, or (iii) that the search query includes the maximum number of characters; and
providing the search results on the display in response to determining (i) that all identified search results responsive to the search query can be simultaneously provided on the display, (ii) that adding one or more additional characters to the search query up to the maximum number of characters will not reduce the number of search results responsive to the search query to a number greater than zero, or (iii) that the search query includes the maximum number of characters.

2. The method of claim 1, wherein the display is mounted to, or integrated into, a dashboard of a vehicle.

3. The method of claim 1, wherein providing the search results on the display in response to determining (i) that all identified search results responsive to the search query can be simultaneously provided on the display, (ii) that adding one or more additional characters to the search query up to the maximum number of characters will not reduce the number of search results responsive to the search query to a number greater than zero, or (iii) that the search query includes the maximum number of characters comprises:
providing the search results on the display in response to determining that all identified search results responsive to the search query can be simultaneously provided on the display.

4. The method of claim 3, wherein determining that all identified search results responsive to the search query can be simultaneously provided on a display comprises:
determining a number of search results that can be simultaneously provided on the display;
determining the number of search results responsive to the search query; and
determining that the number of search results responsive to the search query is equal to or less than the number of search results that can be simultaneously provided on the display.

5. The method of claim 1, wherein providing the search results on the display in response to determining (i) that all identified search results responsive to the search query can be simultaneously provided on the display, (ii) that adding one or more additional characters to the search query up to the maximum number of characters will not reduce the number of search results responsive to the search query to a number greater than zero, or (iii) that the search query includes the maximum number of characters comprises:
providing the search results on the display in response to determining that adding one or more additional characters to the search query up to the maximum number of characters will not reduce the number of search results responsive to the search query to a number greater than zero.

6. The method of claim 5, wherein determining that adding one or more additional characters to the search query up to the maximum number of characters will not reduce the number of search results responsive to the search query to a number greater than zero comprises:
determining that adding any character to the search query when the search query includes less than the maximum number of characters either results in no search results being responsive to the search query or a same set of results being responsive to the search query.

7. The method of claim 1, wherein providing the search results on the display in response to determining (i) that all identified search results responsive to the search query can be simultaneously provided on a display, (ii) that adding one or more additional characters to the search query up to the maximum number of characters will not reduce the number of search results responsive to the search query to a number greater than zero, or (iii) that the search query includes the maximum number of characters comprises:
providing the search results on the display in response to determining that the search query includes the maximum number of characters.

8. The method of claim 7, wherein determining that the search query includes the maximum number of characters comprises:
determining the maximum number of characters that can be included in search queries; and
determining that the number of characters in the search query equals the maximum number of characters that can be included in search queries.

9. The method of claim 1, wherein the characters comprise alphanumeric characters.

10. The method of claim 1, wherein a search result is responsive to a search query when any word in a title of the search result begins with the characters in the search query.

11. The method of claim 1, wherein receiving user input specifying a character to be included in a search query comprises:
appending the character to the search query.

12. The method of claim 1, wherein the display is used in a vehicle or transportation device.

13. A system comprising:
one or more computers and one or more storage devices storing instructions that are operable, when executed by the one or more computers, to cause the one or more computers to perform operations comprising:
receiving user input specifying a character to be included in a search query;
determining (i) that all identified search results responsive to the search query can be simultaneously provided on a display, (ii) that adding one or more additional characters to the search query up to a maximum number of characters will not reduce the number of search results responsive to the search query to a number greater than zero, or (iii) that the search query includes the maximum number of characters; and
providing the search results on the display in response to determining (i) that all identified search results responsive to the search query can be simultaneously provided on the display, (ii) that adding one or more additional characters to the search query up to the maximum number of characters will not reduce the number of search results responsive to the search query to a number greater than zero, or (iii) that the search query includes the maximum number of characters.

14. The system of claim 13, wherein the display is mounted to, or integrated into, a dashboard of a vehicle.

15. The system of claim 13, wherein providing the search results on the display in response to determining (i) that all identified search results responsive to the search query can be simultaneously provided on the display, (ii) that adding one or more additional characters to the search query up to the maximum number of characters will not reduce the number of search results responsive to the search query to a number greater than zero, or (iii) that the search query includes the maximum number of characters comprises:
providing the search results on the display in response to determining that all identified search results responsive to the search query can be simultaneously provided on the display.

16. The system of claim 15, wherein determining that all identified search results responsive to the search query can be simultaneously provided on a display comprises:
determining a number of search results that can be simultaneously provided on the display;
determining the number of search results responsive to the search query; and
determining that the number of search results responsive to the search query is equal to or less than the number of search results that can be simultaneously provided on the display.

17. The system of claim 13, wherein providing the search results on the display in response to determining (i) that all identified search results responsive to the search query can be simultaneously provided on the display, (ii) that adding one or more additional characters to the search query up to the maximum number of characters will not reduce the number of search results responsive to the search query to a number greater than zero, or (iii) that the search query includes the maximum number of characters comprises:
providing the search results on the display in response to determining that adding one or more additional characters to the search query up to the maximum number of characters will not reduce the number of search results responsive to the search query to a number greater than zero.

18. The system of claim 17, wherein determining that adding one or more additional characters to the search query up to the maximum number of characters will not reduce the number of search results responsive to the search query to a number greater than zero comprises:
determining that adding any character to the search query when the search query includes less than the maximum number of characters either results in no search results being responsive to the search query or a same set of results being responsive to the search query.

19. The system of claim 13, wherein providing the search results on the display in response to determining (i) that all identified search results responsive to the search query can be simultaneously provided on a display, (ii) that adding one or more additional characters to the search query up to the maximum number of characters will not reduce the number of search results responsive to the search query to a number greater than zero, or (iii) that the search query includes the maximum number of characters comprises:
providing the search results on the display in response to determining that the search query includes the maximum number of characters.

20. A computer-readable storage device encoded with a computer program, the program comprising instructions that when executed by one or more computers cause the one or more computers to perform operations comprising:
receiving user input specifying a character to be included in a search query;
determining (i) that all identified search results responsive to the search query can be simultaneously provided on a display, (ii) that adding one or more additional characters to the search query up to a maximum number of characters will not reduce the number of search results responsive to the search query to a number greater than zero, or (iii) that the search query includes the maximum number of characters; and
providing the search results on the display in response to determining (i) that all identified search results responsive to the search query can be simultaneously provided on the display, (ii) that adding one or more additional characters to the search query up to the maximum number of characters will not reduce the number of search results responsive to the search query to a number greater than zero, or (iii) that the search query includes the maximum number of characters.
